(19) United States
(12) Patent Application Publication
(10) Pub. No.: US 2019/0095563 A1
(43) Pub. Date: Mar. 28, 2019

(54) Printed Circuit Board Thermal Conductivity Determination

(71) Applicant: Mentor Graphics Corporation, Wilsonville, OR (US)

(72) Inventor: Paul Richard Blais, South Burlington, VT (US)

(21) Appl. No.: 16/105,411

(22) Filed: Aug. 20, 2018

Related U.S. Application Data
(60) Provisional application No. 62/562,637, filed on Sep. 25, 2017.

(51) Int. Cl. G06F 17/50

(52) U.S. Cl. CPC G06F 17/5036

(57) ABSTRACT

Various aspects of the disclosed technology relate to effective thermal conductivity determination. A first thermal simulation is performed on a whole or a section of the printed circuit board to derive a first heat transfer rate. A second thermal simulation is performed on the whole or the section of the printed circuit board to derive a second heat transfer rate. For the second thermal simulation, a layer of the printed circuit board is replaced with a layer made of a dielectric material. An effective thermal conductivity property value for the whole or the section of the layer of the printed circuit board is then computed based on a difference between the first heat transfer rate and the second heat transfer rate. A thermal conductance curve may be generated using the effective thermal conductivity property values derived for a plurality of samples.

### RELATED APPLICATIONS

This application claims the benefit of U.S. Provisional Patent Application No. 62/562,637, filed on Sep. 25, 2017, titled “Printed Circuit Board Thermal Conductivity Determination,” and naming Paul Richard Blais as inventor, which application is incorporated entirely herein by reference.

### FIELD OF THE DISCLOSED TECHNIQUES

The presently disclosed techniques relates to thermal simulation aspects of product design. Various implementations of the disclosed techniques may be particularly useful for determining effective thermal conductivity values for a section or a whole of a layer of a printed circuit board.

### BACKGROUND OF THE DISCLOSED TECHNIQUES

High operating temperatures can severely affect the performance, power consumption and reliability of a circuit system. With the continued scaling of integrated circuit technologies, high power density and the resulting difficulties in managing temperatures have become a major challenge facing designers at all design levels. Computer modeling tools have been employed to predict and simulate the thermal behavior of both physical and virtual structures.

A printed circuit board is typically a layered composite consisting of copper foil and a glass-reinforced polymer (FR-4). It mechanically supports and electrically connects electronic components or electrical components. Printed circuit boards are used in all but the simplest electronic products. They are also used in some electrical products, such as passive switch boxes. A common type of printed circuit board is usually 10 cm wide, 15 cm long and a few millimeters thick. Printed circuit boards can be singled sided, double sided and multilayered. Multilayer printed circuit boards have one or multiple conductor patterns (layers) inside the board, insolated by dielectric layers. This increases the area available for wiring. A smart phone may have a printed circuit board consisting of more than ten layers. Through the conductor layers, a printed circuit board can help to remove component heat. To preserve component reliability, efficient thermal design and management is needed.

When performing a steady-state thermal analysis on a printed circuit board, one of the critical parameters is the effective thermal conductivity. The accuracy of the effective thermal conductivity value for each of the printed circuit board layers can determine the accuracy of the thermal model. No two printed circuit boards are designed alike, but employing an accurate three-dimensional model to predict temperature distribution takes an excessive amount of time. A current method determines the amount of conductor on each layer of the printed circuit board and then converts it into appropriately weighted thermal conductivity values for the analysis. The conversion involves either using a volume fraction (VF) calculation for the entire printed circuit board or a volume fraction calculation for each individual layer separately (VFIL). Thermal conductivity values derived by the volume fraction conversion method are often much higher than reality, resulting in an under-prediction of temperatures. The VFIL method, on the other hand, fails to capture the interaction between layers, deriving thermal conductivity less than actual values and resulting an over-prediction of temperatures.

### BRIEF SUMMARY OF THE DISCLOSED TECHNIQUES

Various aspects of the disclosed technology relate to effective thermal conductivity determination. In one aspect, there is a method, executed by at least one processor of a computer, comprising: receiving data of a printed circuit board; performing a first thermal simulation on a whole or a section of the printed circuit board to derive a first heat transfer rate for a heat flow from one side of the whole or the section of the printed circuit board to an opposite side of the whole or the section of the printed circuit board under a temperature difference; performing a second thermal simulation on the whole or the section of the printed circuit board to derive a second heat transfer rate for a heat flow from the one side of the whole or the section of the printed circuit board to the opposite side of the whole or the section of the printed circuit board under the temperature difference, wherein the second thermal simulation replaces a layer of the printed circuit board with a layer made of a dielectric material having a size equal to the layer of the printed circuit board; computing an effective thermal conductivity property value for the whole or the section of the layer of the printed circuit board based on a difference between the first heat transfer rate and the second heat transfer rate; and storing the effective thermal conductivity property value on a non-transitory computer-readable medium.

The method may further comprise: repeating the performing a first thermal simulation, the performing a second thermal simulation and the computing an effective thermal conductivity property value for different sections of the printed circuit board, different printed circuit boards, or both to derive a plurality of effective thermal conductivity property values; and generating conductor material proportion-vs-effective thermal conductivity information based on the plurality of effective thermal conductivity property values and corresponding proportion values of a conductor material. The method may still further comprise: deriving an effective thermal conductivity property value for a whole or a section of a layer of a second printed circuit board based on the conductor material proportion-vs-effective thermal conductivity information and a proportion value of conductor material for the whole or the section of the layer of the second printed circuit board. The conductor material proportion-vs-effective thermal conductivity information may be represented by a curve of effective thermal conductivity vs. percentage of the conductor material.

The dielectric material may be FR-4 (a woven fiberglass cloth impregnated with an epoxy resin) and a conductor material for the printed circuit board may be copper. The first thermal simulation and the second thermal simulation may employ a three-dimensional computational fluid dynamics (CFD) software tool.

In another aspect, there are one or more non-transitory computer-readable media storing computer-executable instructions for causing one or more processors to perform the above method.

In still another aspect, there is a system, comprising: one or more processors, the one or more processors programmed to perform the above method.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclose techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates a programmable computer system with which various embodiments of the disclosed technology may be employed.

FIG. 2 illustrates a thermal conductivity determination tool that may be implemented according to various embodiments of the disclosed technology.

FIG. 3 illustrates a flowchart showing a process of effective thermal conductivity determination that may be implemented according to various examples of the disclosed technology.

FIG. 4 illustrates an example of a thermal simulation setup for a printed circuit board.

FIG. 5 illustrates an example of a printed circuit board having twelve square sections for effective thermal conductivity determination.

FIG. 6 illustrates an example of replacing a layer of a printed circuit board with a layer made of dielectric material for effective thermal conductivity determination.

FIG. 7 illustrates an example of the effective thermal conductivity curve derived by fitting a plurality of effective thermal conductivity property values which are determined according to some embodiments of the disclosed technology.

FIG. 8 compares thermal conductance values derived using an relative actual thermal model (labeled as “Analysis”), with the ones derived using a method according to an embodiment of the disclosed technology (labeled as “Layered”), and with the ones derived using the volume fraction method (labeled as “Volume Fraction”) for two different samples (810 and 820) in two different directions ((labeled as “X Dir” and “Y Dir”, respectively).

### DETAILED DESCRIPTION OF THE DISCLOSED TECHNIQUES

### General Considerations

Various aspects of the disclosed technology relate to effective thermal conductivity determination. In the following description, numerous details are set forth for the purpose of explanation. However, one of ordinary skill in the art will realize that the disclosed technology may be practiced without the use of these specific details. In other instances, well-known features have not been described in details to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of a thermal modeling tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “perform” and “compute” to describe the disclosed method or the device function/structure. Such terms are high-level descriptions. The actual operations or functions/structures that correspond to these terms will vary depending on the particular implementation and are readily discernible by one of ordinary skill in the art.

### Illustrative Operating Environment

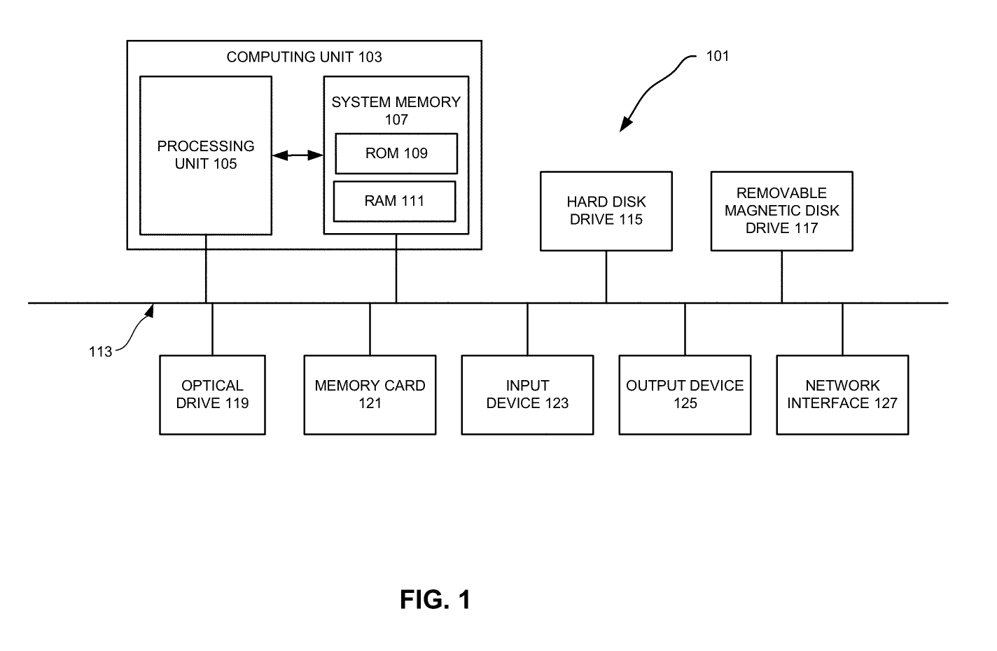

Various examples of the disclosed technology may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but it will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it is not intended to be limiting. Various embodiments of the disclosed technology may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the disclosed technology may be implemented using a multi-processor computer, a plurality of single and/or multiprocessor computers arranged into a network, or some combination of both.

### Thermal Conductivity Determination Tool

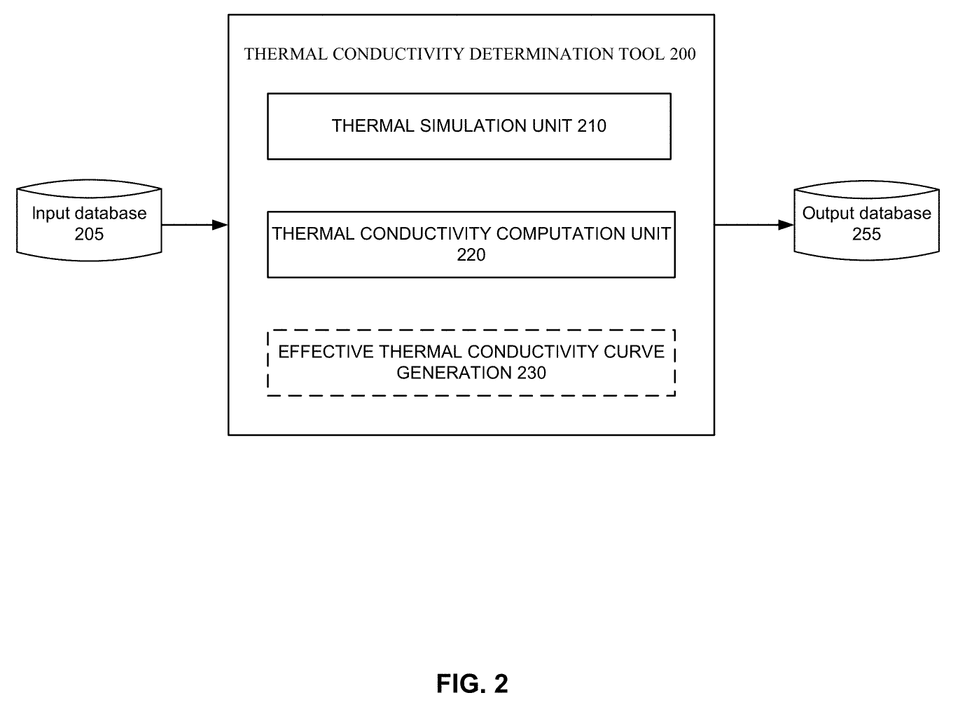

FIG. 2 illustrates an example of a thermal conductivity determination tool 200 that may be implemented according to various embodiments of the disclosed technology. As seen in this figure, the thermal conductivity determination tool 200 includes a thermal simulation unit 210 and a thermal conductivity computation unit 220. Some implementations of the thermal conductivity determination tool 200 may cooperate with (or incorporate) one or more of an effective thermal conductivity curve generation unit 230, an input database 205, and an output database 255.

As will be discussed in more detail below, the thermal conductivity determination tool 200 receives data of a printed circuit board from the input database 205. The thermal simulation unit 210 performs a first thermal simulation on a whole or a section of the printed circuit board to derive a first heat transfer rate for a heat flow from one side of the whole or the section of the printed circuit board to an opposite side of the whole or the section of the printed circuit board under a temperature difference. The thermal simulation unit 210 also performs a second thermal simulation on the whole or the section of the printed circuit board to derive a second heat transfer rate for a heat flow from the one side of the whole or the section of the printed circuit board to the opposite side of the whole or the section of the printed circuit board under the temperature difference. The second thermal simulation replaces a layer of the printed circuit board with a layer of a dielectric material having a size equal to the layer of the printed circuit board. The thermal conductivity computation unit 220 computes an effective thermal conductivity property value for the whole or the section of the layer of the printed circuit board based on a difference between the first heat transfer rate and the second heat transfer rate, the temperature difference, a thermal conductivity property value for the dielectric material, and size information of the layer of the printed circuit board. The thermal conductivity determination tool 200 stores the effective thermal conductivity property value on a non-transitory computer-readable medium. Additionally, the thermal conductivity determination tool 200 may repeat the performing a first thermal simulation, the performing a second thermal simulation and the computing an effective thermal conductivity property value for different sections of the printed circuit board, different printed circuit boards, or both to derive a plurality of effective thermal conductivity property values. The effective thermal conductivity curve generation unit 230 may generate conductor material proportion-vs-effective thermal conductivity information based on the plurality of effective thermal conductivity property values and corresponding proportion values of a conductor material.

As previously noted, various examples of the disclosed technology may be implemented by one or more computing systems, such as the computing system illustrated in FIG. 1. Accordingly, one or more of the thermal simulation unit 210, the thermal conductivity computation unit 220 and the effective thermal conductivity curve generation unit 230 may be implemented by executing programming instructions on one or more processors in one or more computing systems, such as the computing system illustrated in FIG. 1. Correspondingly, some other embodiments of the disclosed technology may be implemented by software instructions, stored on a non-transitory computer-readable medium, for instructing one or more programmable computers/computer systems to perform the functions of one or more of the thermal simulation unit 210, the thermal conductivity computation unit 220 and the effective thermal conductivity curve generation unit 230. As used herein, the term “non-transitory computer-readable medium” refers to computer-readable medium that are capable of storing data for future retrieval and not propagating electro-magnetic waves. The non-transitory computer-readable medium may be, for example, a magnetic storage device, an optical storage device, or a solid state storage device.

It also should be appreciated that, while the thermal simulation unit 210, the thermal conductivity computation unit 220 and the effective thermal conductivity curve generation unit 230 are shown as separate units in FIG. 2, a single computer (or a single processor within a master computer) or a single computer system may be used to implement all of these units at different times, or components of these units at different times.

With various examples of the disclosed technology, the input database 205 and the output database 255 may be implemented using any suitable computer readable storage device. That is, either of the input database 205 and the output database 255 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, holographic storage devices, or any other non-transitory storage medium that can be used to store desired information. While the input database 205 and the output database 255 are shown as separate units in FIG. 2, a single data storage medium may be used to implement some or all of these databases.

### Effective Thermal Conductivity Determination

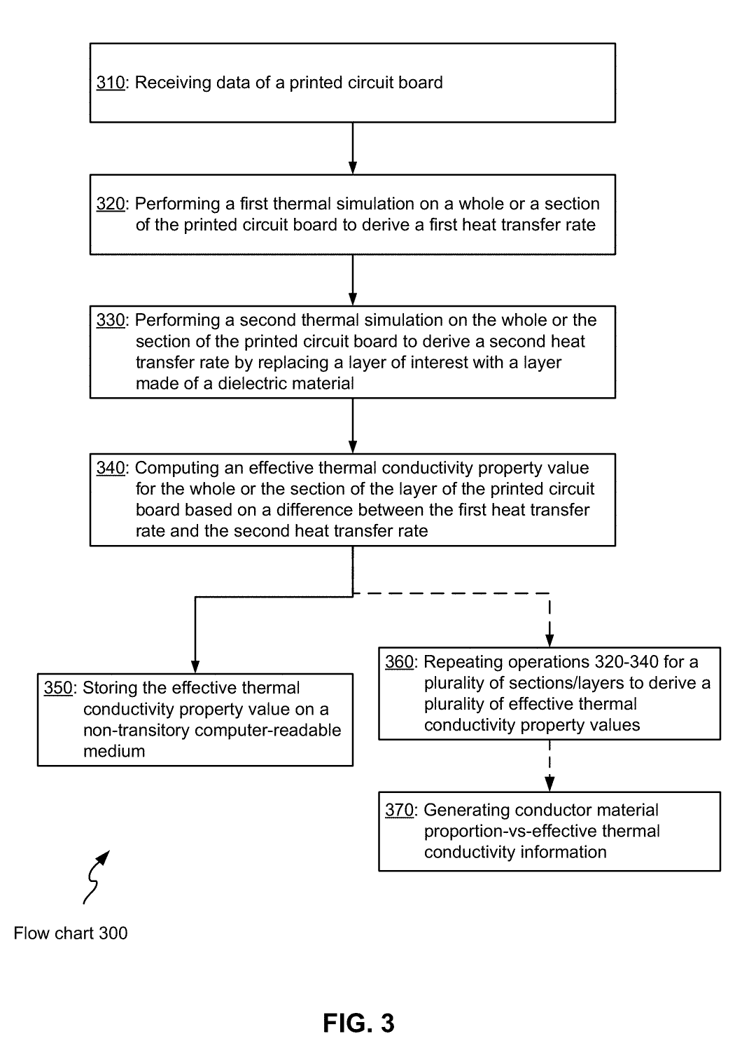

FIG. 3 illustrates a flowchart 300 showing a process of effective thermal conductivity determination that may be implemented according to various examples of the disclosed technology. For ease of understanding, methods of effective thermal conductivity determination that may be employed according to various embodiments of the disclosed technology will be described with reference to the thermal conductivity determination tool 200 illustrated in FIG. 2 and the flow chart 300 in FIG. 3. It should be appreciated, however, that alternate implementations of a thermal conductivity determination tool 200 may be used to perform the method of effective thermal conductivity determination illustrated by the flow chart 300 according to various embodiments of the disclosed technology. In addition, it should be appreciated that implementations of the thermal conductivity determination tool 200 may be employed to implement methods of effective thermal conductivity determination according to different embodiments of the disclosed technology other than the one illustrated by the flow chart 300 in FIG. 3.

In operation 310, the thermal conductivity determination tool 200 receives data of a printed circuit board from the input database 205. The data of a printed circuit board may comprise size such as cross section area and length and width values. The data of a printed circuit board may also comprise layer information of the printed circuit board. The layer information may comprise conductor topology information.

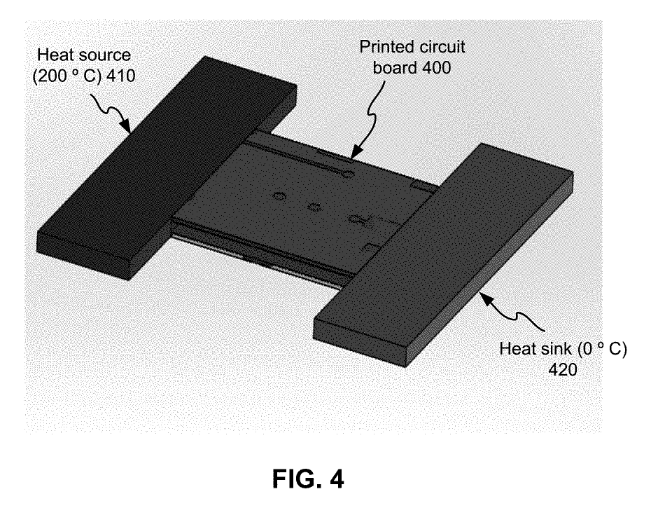

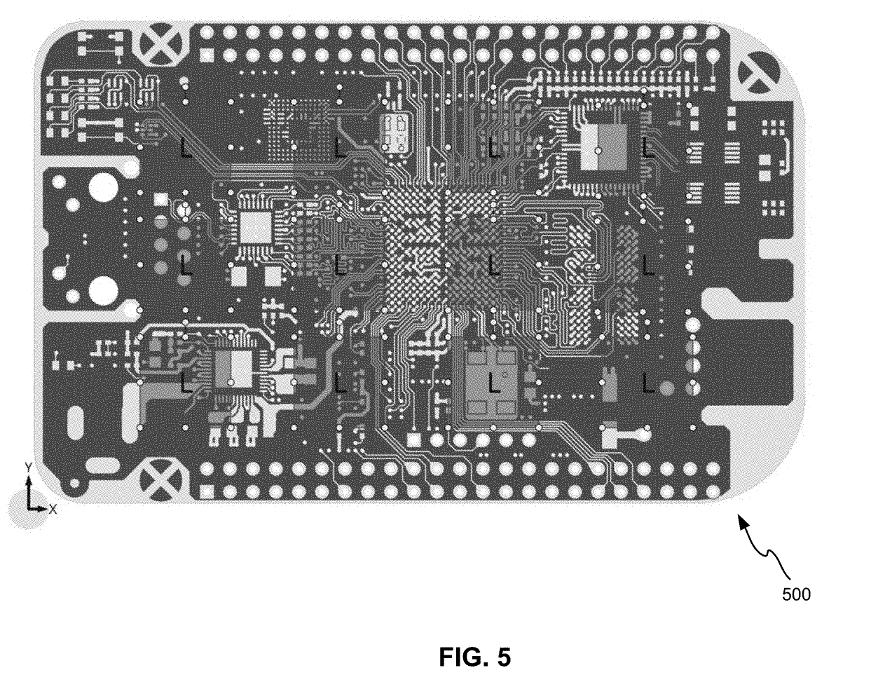

In operation 320, the thermal simulation unit 210 performs a first thermal simulation on a whole or a section of the printed circuit board to derive a first heat transfer rate for a heat flow from one side of the whole or the section of the printed circuit board to an opposite side of the whole or the section of the printed circuit board under a temperature difference. The thermal simulation unit 210 may employ a three-dimensional thermal model for thermal simulation. FIG. 4 illustrates an example of a thermal simulation setup for a printed circuit board 400. The printed circuit board 400 is placed between a heat source 410 and a heat sink 420. The temperature of the heat source is 200 degree C. and the temperature of the sink is 0 degree C. The first thermal simulation can determine the heat transfer rate for the heat flowing from the heat source 410 through the printed circuit board 400 to the heat sink 420. The printed circuit board 400 may be a whole of an original printed circuit board or a section of the original printed circuit board. FIG. 5 illustrates an example of a printed circuit board 500 having twelve square sections for effective thermal conductivity determination. Any of the twelve square sections can be the printed circuit board 400.

The thermal simulation unit 210 may be implemented by a commercial thermal simulation tool. An example of such a tool is the FloTHERM® family of software products available from Mentor Graphics Corporation of Wilsonville, Oreg.

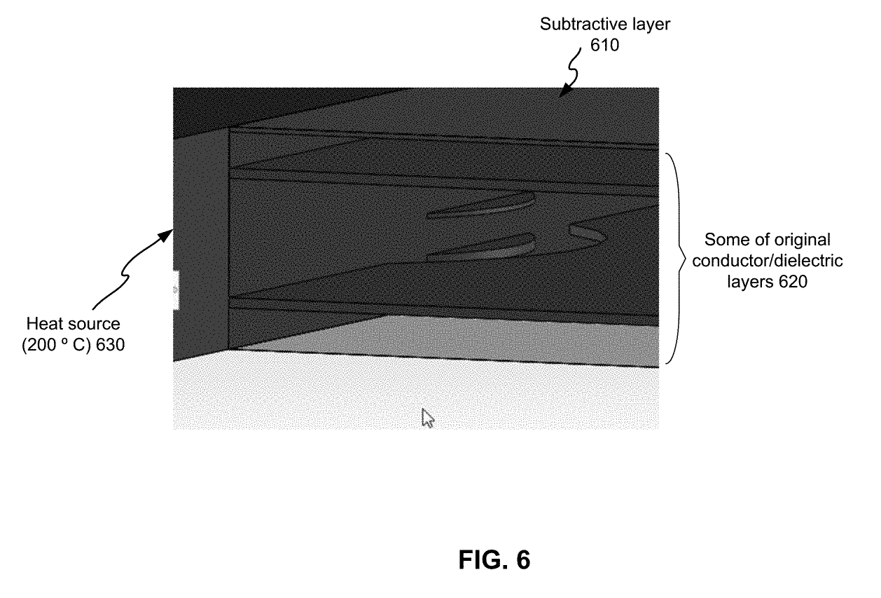

In operation 330, the thermal simulation unit 210 performs a second thermal simulation on the whole or the section of the printed circuit board to derive a second heat transfer rate for a heat flow from the one side of the whole or the section of the printed circuit board to the opposite side of the whole or the section of the printed circuit board. The second thermal simulation is similar to the first thermal simulation. They use the same thermal model and under the same conditions such as the temperature difference and the size of the whole or the section of the printed circuit board. There is one difference: in the second thermal simulation, a layer made of a dielectric material (subtractive layer) replaces a layer of the printed circuit board for which the thermal conductivity determination tool 200 is trying to determine an effective thermal conductivity value. The subtractive layer has no conductor material and has a size equal to the layer being replaced. The derived second heat transfer rate thus is different from the first heat transfer rate. FIG. 6 illustrates such an example. The figure shows a subtractive layer 610 some of the original conductor layers and dielectric layers 620 and a heat source 630 which has a temperature of 200 degree C.

In operation 340, the thermal conductivity computation unit 220 computes an effective thermal conductivity property value for the whole or the section of the layer of the printed circuit board based on a difference between the first heat transfer rate and the second heat transfer rate. Assume the first heat transfer rate derived in the operation 320 is represented by Q_{full}. The following equation represents the relationship of Q_{full} with the effective thermal conductance k_{eff}_{_}_{full}, the distance L between the heat source and the heat sink, the temperature difference ΔT between the heat source and the heat sink (e.g., 200 degree C.), and the area A of the cross section of the printed circuit board:

$${k}_{eff\_full} = \frac{{Q}_{full} * L}{Δ T * A} \qquad ( 1 )$$

Similarly, the second heat transfer rate represented by Q_{full}_{_}_{sub} has a relationship with the effective thermal conductance k_{eff}_{_}_{full}_{_}_{sub}, the distance L between the heat source and the heat sink, the temperature difference ΔT between the heat source and the heat sink (e.g., 200 degree C.), and the area A of the cross section of the printed circuit board:

$${k}_{eff\_full \_sub} = \frac{{Q}_{full\_sub} * L}{Δ T * A} \qquad ( 2 )$$

Subtract the above two equations:

$${k}_{eff\_full} - {k}_{eff\_full \_sub} = \frac{( {Q}_{full} - {Q}_{full\_sub} ) * L}{Δ T * A} \qquad ( 3 )$$

The effective thermal conductance k_{eff}_{_}_{full} and the effective thermal conductance k_{eff}_{_}_{full}_{_}_{sub} can also be expressed in terms of the effective thermal conductance for the individual layers k_{layer}:

$$\begin{matrix}{k}_{eff\_full} = \frac{( {\sum }_{o}^{n - 1} {k}_{layer} * {t}_{layer} ) + ( {k}_{sub\_layer} * {t}_{sub\_layer} )}{{t}_{total}} & ( 4 ) \\ {k}_{eff\_full \_sub} = \frac{( {\sum }_{o}^{n - 1} {k}_{layer} * {t}_{layer} ) + ( {k}_{dielectric} * {t}_{sub\_layer} )}{{t}_{total}} & ( 5 )\end{matrix}$$

where k_{sub}_{_}_{layer} is the effective thermal conductance for the layer of interest, k_{dielectric} is the thermal conductance for the dielectric material such as FR-4, tₜₒₜₐₗ is the thickness of the printed circuit board, and t_{layer} is the thickness of the layer.

Subtract Eq. (5) from Eq. (4):

$${k}_{eff\_full} - {k}_{eff\_full \_sub} = \frac{( {k}_{sub\_layer} - {k}_{dielectric} ) * {t}_{sub\_layer}}{{t}_{total}} \qquad ( 6 )$$

Combining Eqs. (3) and (6):

$$\frac{( {k}_{sub\_layer} - {k}_{FR 4} ) * {t}_{sub\_layer}}{{t}_{total}} = \frac{( {Q}_{full} - {Q}_{sub\_layer} ) * L}{Δ T * {t}_{total} * W )} \qquad ( 7 )$$

Rearranging Eq. (6), the effective thermal conductivity property value for the whole or the section of the layer of the printed circuit board can be, according to various embodiments of the disclosed technology, expressed as:

$${k}_{sub\_layer} = ( \frac{( {Q}_{full} - {Q}_{sub\_layer} ) * L}{Δ T * {t}_{sub\_layer} * W )} ) + {k}_{dielectric} \qquad ( 8 )$$

Here Q_{full} and Q_{sub}_{_}_{layer} are derived in the operations 320 and 330, respectively. Because of the subtraction used in Eqs. (3) and (6), the disclosed technology may be referred to as a subtractive layer method. The disclosed technology can be used to determine the in-plane effective thermal conductance values in both x and y directions.

In operation 350, the thermal conductivity determination tool 200 stores the effective thermal conductivity property value in the output database 255.

Optionally, in operation 360, the effective thermal conductivity curve generation unit 230 repeats the operations 320, 330 and 340 for different sections of the printed circuit board, different printed circuit boards, or both to derive a plurality of effective thermal conductivity property values. In operation 370, the effective thermal conductivity curve generation unit 230 generating conductor material proportion-vs-effective thermal conductivity information based on the plurality of effective thermal conductivity property values and corresponding proportion values of a conductor material. The conductor material proportion-vs-effective thermal conductivity information may be represented by a curve of effective thermal conductivity vs. percentage of the conductor material. The curve of effective thermal conductivity vs. percentage of the conductor material may be used to derive an effective thermal conductivity property value for a whole or a section of a layer of a second printed circuit board based on the conductor material proportion-vs-effective thermal conductivity information and a proportion value of conductor material for the whole or the section of the layer of the second printed circuit board.

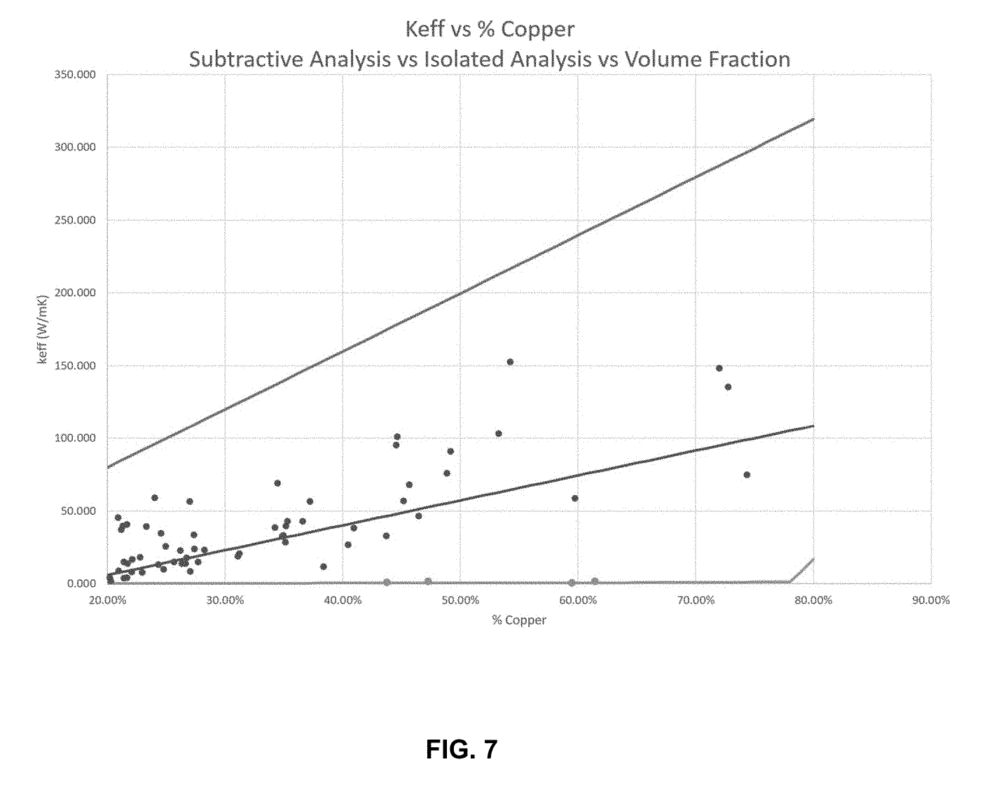

FIG. 7 illustrates an example of the curve of effective thermal conductivity vs. percentage of the conductor material derived by fitting a plurality of effective thermal conductivity property values which are determined according to some embodiments of the disclosed technology. In the figure, the plurality of effective thermal conductivity property values are shown by dots. The effective thermal conductivity curve 710 derived according to some embodiments of the disclosed technology are compared with one derived based on the volume fraction method (720) and one derived based on an isolated layer analysis method (730). As noted in the Background section, the curve 720 over-predicts the thermal conductance while the curve 730 under-predicts the thermal conductance. By contrast, the curve 710 are closer to the actual thermal conductance values.

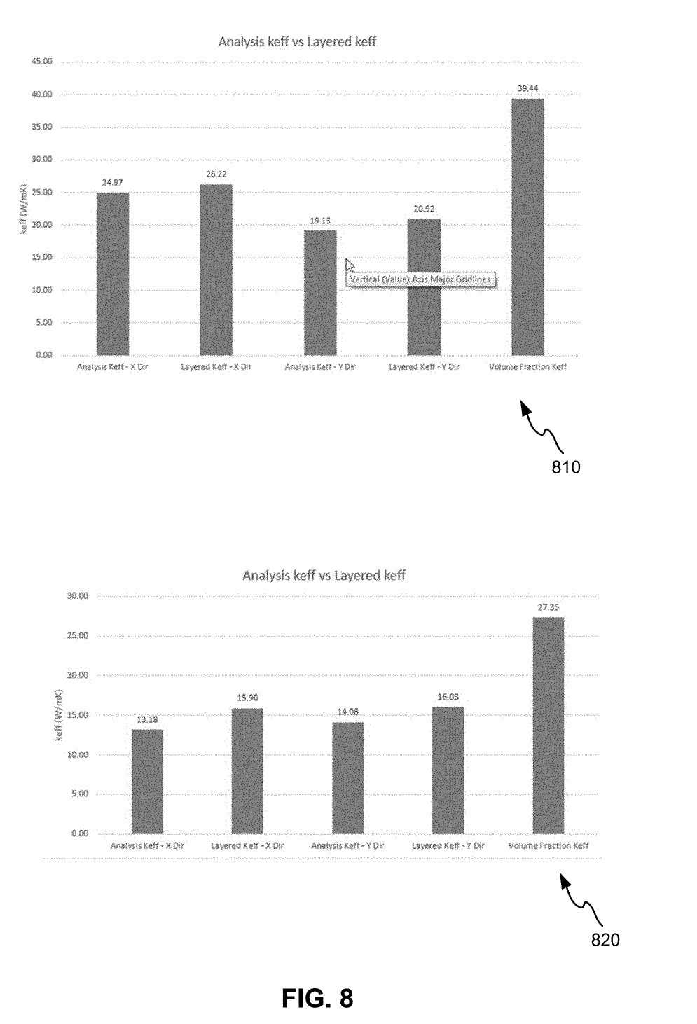

FIG. 8 compares thermal conductance values derived using an relative actual thermal model (labeled as “Analysis”), with the ones derived using a method according to an embodiment of the disclosed technology (labeled as “Layered”), and with the ones derived using the volume fraction method (labeled as “Volume Fraction”) for two different samples (810 and 820) in two different directions ((labeled as “X Dir” and “Y Dir”, respectively). Again, FIG. 8 shows that the disclosed technology can derive effective thermal conductivity property values much closer to the ones derived using a more accurate thermal model than the volume fraction method.

### CONCLUSION

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

What is claimed is:

1. A method, executed by at least one processor of a computer, comprising:
receiving data of a printed circuit board;
performing a first thermal simulation on a whole or a section of the printed circuit board to derive a first heat transfer rate for a heat flow from one side of the whole or the section of the printed circuit board to an opposite side of the whole or the section of the printed circuit board under a temperature difference;
performing a second thermal simulation on the whole or the section of the printed circuit board to derive a second heat transfer rate for a heat flow from the one side of the whole or the section of the printed circuit board to the opposite side of the whole or the section of the printed circuit board under the temperature difference, wherein the second thermal simulation replaces a layer of the printed circuit board with a layer made of a dielectric material having a size equal to the layer of the printed circuit board;
computing an effective thermal conductivity property value for the whole or the section of the layer of the printed circuit board based on a difference between the first heat transfer rate and the second heat transfer rate; and
storing the effective thermal conductivity property value on a non-transitory computer-readable medium.

2. The method recited in claim 1, further comprising:
repeating the performing a first thermal simulation, the performing a second thermal simulation and the computing an effective thermal conductivity property value for different sections of the printed circuit board, different printed circuit boards, or both to derive a plurality of effective thermal conductivity property values; and
generating conductor material proportion-vs-effective thermal conductivity information based on the plurality of effective thermal conductivity property values and corresponding proportion values of a conductor material.

3. The method recited in claim 2, further comprising:
deriving an effective thermal conductivity property value for a whole or a section of a layer of a second printed circuit board based on the conductor material proportion-vs-effective thermal conductivity information and a proportion value of conductor material for the whole or the section of the layer of the second printed circuit board.

4. The method recited in claim 2, wherein the conductor material proportion-vs-effective thermal conductivity information is represented by a curve of effective thermal conductivity vs. percentage of the conductor material.

5. The method recited in claim 1, wherein the dielectric material is FR-4 (a woven fiberglass cloth impregnated with an epoxy resin) and a conductor material for the printed circuit board is copper.

6. The method recited in claim 1, wherein the first thermal simulation and the second thermal simulation employ a three-dimensional computational fluid dynamics (CFD) software tool.

7. One or more non-transitory computer-readable media storing computer-executable instructions for causing one or more processors to perform a method, the method comprising:
receiving data of a printed circuit board;
performing a first thermal simulation on a whole or a section of the printed circuit board to derive a first heat transfer rate for a heat flow from one side of the whole or the section of the printed circuit board to an opposite side of the whole or the section of the printed circuit board under a temperature difference;
performing a second thermal simulation on the whole or the section of the printed circuit board to derive a second heat transfer rate for a heat flow from the one side of the whole or the section of the printed circuit board to the opposite side of the whole or the section of the printed circuit board under the temperature difference, wherein the second thermal simulation replaces a layer of the printed circuit board with a layer made of a dielectric material having a size equal to the layer of the printed circuit board;
computing an effective thermal conductivity property value for the whole or the section of the layer of the printed circuit board based on a difference between the first heat transfer rate and the second heat transfer rate; and
storing the effective thermal conductivity property value on a non-transitory computer-readable medium.

8. The one or more non-transitory computer-readable media recited in claim 7, wherein the method further comprises:
repeating the performing a first thermal simulation, the performing a second thermal simulation and the computing an effective thermal conductivity property value for different sections of the printed circuit board, different printed circuit boards, or both to derive a plurality of effective thermal conductivity property values; and
generating conductor material proportion-vs-effective thermal conductivity information based on the plurality of effective thermal conductivity property values and corresponding proportion values of a conductor material.

9. The one or more non-transitory computer-readable media recited in claim 8, wherein the method further comprises:
deriving an effective thermal conductivity property value for a whole or a section of a layer of a second printed circuit board based on the conductor material proportion-vs-effective thermal conductivity information and a proportion value of conductor material for the whole or the section of the layer of the second printed circuit board.

10. The one or more non-transitory computer-readable media recited in claim 8, wherein the conductor material proportion-vs-effective thermal conductivity information is represented by a curve of effective thermal conductivity vs. percentage of the conductor material.

11. The one or more non-transitory computer-readable media recited in claim 7, wherein the dielectric material is FR-4 (a woven fiberglass cloth impregnated with an epoxy resin) and a conductor material for the printed circuit board is copper.

12. The one or more non-transitory computer-readable media recited in claim 7, wherein the first thermal simulation and the second thermal simulation employ a three-dimensional computational fluid dynamics (CFD) software tool.

13. A system, comprising:
one or more processors, the one or more processors programmed to perform a method, the method comprising:
receiving data of a printed circuit board;
performing a first thermal simulation on a whole or a section of the printed circuit board to derive a first heat transfer rate for a heat flow from one side of the whole or the section of the printed circuit board to an opposite side of the whole or the section of the printed circuit board under a temperature difference;
performing a second thermal simulation on the whole or the section of the printed circuit board to derive a second heat transfer rate for a heat flow from the one side of the whole or the section of the printed circuit board to the opposite side of the whole or the section of the printed circuit board under the temperature difference, wherein the second thermal simulation replaces a layer of the printed circuit board with a layer made of a dielectric material having a size equal to the layer of the printed circuit board;
computing an effective thermal conductivity property value for the whole or the section of the layer of the printed circuit board based on a difference between the first heat transfer rate and the second heat transfer rate; and
storing the effective thermal conductivity property value on a non-transitory computer-readable medium.

14. The system recited in claim 13, wherein the method further comprises:
repeating the performing a first thermal simulation, the performing a second thermal simulation and the computing an effective thermal conductivity property value for different sections of the printed circuit board, different printed circuit boards, or both to derive a plurality of effective thermal conductivity property values; and
generating conductor material proportion-vs-effective thermal conductivity information based on the plurality of effective thermal conductivity property values and corresponding proportion values of a conductor material.

15. The system recited in claim 14, wherein the method further comprises:
deriving an effective thermal conductivity property value for a whole or a section of a layer of a second printed circuit board based on the conductor material proportion-vs-effective thermal conductivity information and a proportion value of conductor material for the whole or the section of the layer of the second printed circuit board.

16. The system recited in claim 14, wherein the conductor material proportion-vs-effective thermal conductivity information is represented by a curve of effective thermal conductivity vs. percentage of the conductor material.

17. The system recited in claim 13, wherein the dielectric material is FR-4 (a woven fiberglass cloth impregnated with an epoxy resin) and a conductor material for the printed circuit board is copper.

18. The system recited in claim 13, wherein the first thermal simulation and the second thermal simulation employ a three-dimensional computational fluid dynamics (CFD) software tool.
